(19) United States
(12) Patent Application Publication
(10) Pub. No.: US 2006/0256392 A1
(43) Pub. Date: Nov. 16, 2006

(54) Scanning systems and methods

(75) Inventors: Hubert Van Hoof, Seattle, WA (US); Avijit Sinha, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/129,103

(22) Filed: May 13, 2005

(51) Int. Cl. H04N 1/23

(52) U.S. Cl. 358/402; 358/296

(57) ABSTRACT

In the illustrated and described embodiments, scanning solutions are presented which, from a user's standpoint (either a sender or receiver), are simplistic and intuitive to use. In at least some embodiments, scanned documents can be sent to various digital destinations in which the documents can then be consumed by an end user or system in an intuitive and user-friendly manner. In addition, various embodiments provide infrastructure support for imparting, to the scanning functionality, features that greatly enhance the user's ability to consume and use scanned documents. Other features that can be provided include authentication, the use of scan profiles, post-processing of documents upon acquisition, routing of documents post-processing or upon acquisition or combinations thereof, and integration with other features such as printing, copying and/or faxing to support multi-functionality.

### TECHNICAL FIELD

This invention relates to scanning systems and methods.

### BACKGROUND

To date, the scanning solutions that exist tend to be non-intuitive and often require a generally high level of understanding of not only the scanning system, but the software interface that is presented to a scan user. Typically, in a pull model scanning scenario, the user interfaces with a scanning device via a computer. A user interface is presented to the user in which the user is able to select various scanning parameters for the scanning device and initiate scanning. Once a user's job is scanned, it is typically placed in a temporary scanning location on the user's computer. Yet, this simple description should not imply that the scanning process itself is simple and non-intuitive for the user. Specifically, many scanning systems have detailed software that requires the user to have a fairly detailed knowledge of that software in order to effectively use it.

Needless to say, most if not all of present scanning solutions are not intuitive to use, particularly in the context of document scanning.

In addition, there is a current market trend today towards what are known as multi-function peripheral (MFP) devices. MFP devices are typically devices that have multiple different functionalities, such as scan/print/copy, fax/print/copy, scan/fax/print/copy and the like. In these paradigms, people tend to be generally familiar with the print, fax and copy scenarios and how they are employed. That is, these solutions generally involve selecting a document, sending or placing the document to or on the device, and selecting or pressing the appropriate button on either a displayed user interface (such as in the printing case), or on the device itself (such as in the faxing and copying cases).

Hence, end users tend to utilize these features quite a bit. Yet, the scan functionality tends to be underemployed likely because the scan solutions tend to be more non-intuitive and cumbersome to use.

Accordingly, this invention arose out of concerns associated with providing improved scanning systems and methods.

### SUMMARY

In the illustrated and described embodiments, scanning solutions are presented which, from a user's standpoint (either a sender or receiver), are simplistic and intuitive to use. In at least some embodiments, scanned documents can be sent to various digital destinations in which the documents can then be consumed by an end user or system in an intuitive and user-friendly manner.

In addition, various embodiments provide infrastructure support for imparting, to the scanning functionality, features that greatly enhance the user's ability to consume and use scanned documents. For example, in one embodiment a scanned document can be sent to a digital destination in the form of an “inbox”, such as one that is provided by an application program, such as an email application program. In this embodiment, the scanned document can be presented to the user as the message itself, and not as an attachment. This way, the user can quickly and, at a glance, ascertain the context of the scanned document. Other features that can be provided include authentication, the use of scan profiles, post-processing of documents upon acquisition, routing of documents post-processing or upon acquisition or combinations thereof, and integration with other features such as printing, copying and/or faxing to support multi-functionality.

### BRIEF DESCRIPTION OF THE DRAWINGS

FIG. 1 is a high level overview of a system, including a scan device, in accordance with one embodiment.

FIG. 2 illustrates an exemplary digital destination in accordance with one embodiment.

FIG. 3 is a high level overview of a system, including a multifunction peripheral device, in accordance with one embodiment.

FIG. 4 illustrates an exemplary digital destination in accordance with one embodiment.

FIG. 5 illustrates an exemplary implementation in accordance with one embodiment.

### DETAILED DESCRIPTION

Overview

In the illustrated and described embodiments, scanning solutions are presented which, from a user's standpoint (either a sender or receiver), are simplistic and intuitive to use. In at least some embodiments, scanned documents can be sent to various digital destinations in which the documents can then be consumed by an end user or system in an intuitive and user-friendly manner. In the context of this application, the term “document” will be understood to include any medium that can be scanned using a scanning device. Such can include, by way of example and not limitation, paper documents, photographs, pictures and the like.

In addition, various embodiments provide infrastructure support for imparting, to the scanning functionality, features that greatly enhance the user's ability to consume and use scanned documents. For example, in one embodiment a scanned document can be sent to a digital destination in the form of an “inbox”, such as one that is provided by an application program such as Microsoft's Outlook® program. In this embodiment, the scanned document can be presented to the user as the message itself, and not as an attachment. This way, the user can quickly and, at a glance, ascertain the context of the scanned document. Other features that can be provided include authentication, the use of scan profiles, post-processing of documents upon acquisition, routing of documents post-processing or upon acquisition or combinations thereof, and integration with other features such as printing, copying and/or faxing to support multi-functionality, all of which is discussed below in more detail.

In the discussion that follows, the scanning functionality is discussed in various contexts. In a first section entitled “Scanning to a Digital Destination”, the notion of delivery of scanned documents to various digital destinations that can be accessed by a user is discussed. Following this, a section entitled “Multi-Function Integration” discusses how the inventive scanning functionality can be integrated with other functionalities, such as email, printing, faxing and the like. Following this section, a section entitled “Implementation Example” describes a specific implementation which illustrates the flexibility and robustness of the inventive functionality.

Scanning to a Digital Destination

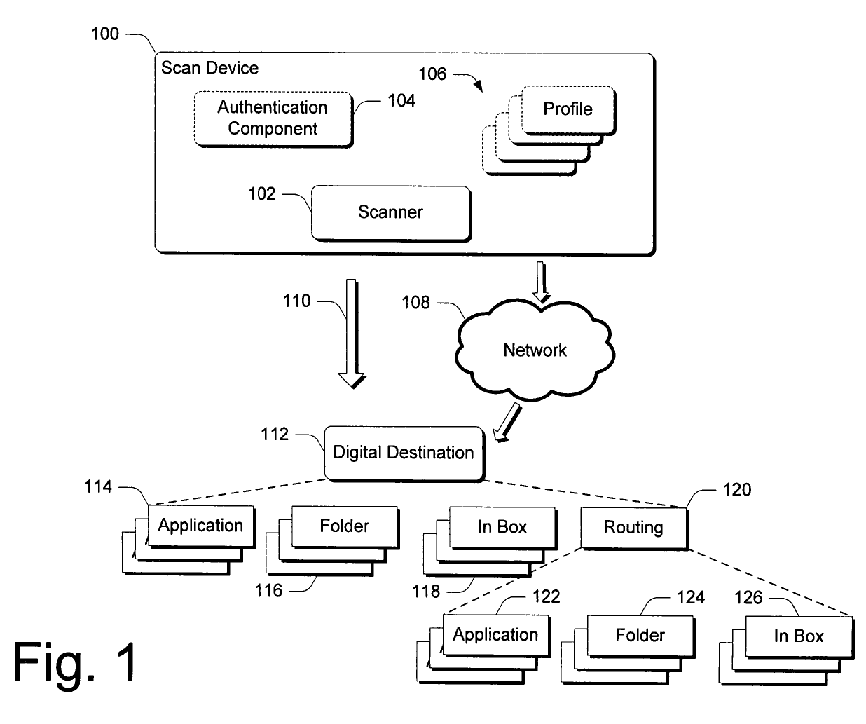

FIG. 1 is a high level illustration of a system in accordance with one embodiment. In this example, the system includes a scan device 100. Typically a scan device will include one or more processors, computer-readable media and various hardware, software and firmware components to provide scanning functionality. For purposes of brevity, however, these components are not shown. It is to be appreciated that the various components and/or their particular functionality can be implemented by computer-readable instructions which reside on some type of computer-readable media.

In this particular example, the scan device is a standalone scan device. It is to be appreciated and understood that device 100 may include other functionalities, as will be described below.

In this example, scan device 100 includes a scanner 102 that is configured to produce scanned documents. In addition, the scan device can optionally include an authentication component 104 for authenticating users, as well as one or more scan profiles 106 that can be selected either automatically or by a user to select one or more destinations for a scanned document. The authentication component and scan profiles are discussed below in more detail.

Scanner 102 is configured to produce, in the usual fashion, scanned documents as will be appreciated by the skilled artisan. Accordingly, for the sake of brevity, scan production is not discussed further. Once a scanned document has been produced, it can be transmitted, either via a network 108 or to a direct connected device, as indicated by arrow 110, to what is referred to as a digital destination 112. The digital destination can typically reside on some type of computing device such as a server, desktop computer, laptop computer, handheld computer and the like. Alternately or additionally, the digital destination can reside in the form of a hardware device, such as a print device or fax device. In at least some embodiments, the digital destination is not a device from which scanning was initiated.

Examples of digital destinations include, by way of example and not limitation, one or more applications 114, one or more folders 116, one or more inboxes 118 and/or one or more routing components 120 which can, in turn, route the scanned document to other digital destinations, such as one or more applications 112, one or more folders 124 and/or one or more inboxes 126.

In accordance with one embodiment, when a scanned document is received at a digital destination, it can be presented to a user via a viewer. For example, in the context of an inbox, such as inbox 118, the scanned document can be presented as a message itself which can be immediately viewed by the user. Presentation of a scanned document in this regard is similar to presentation of an email message. That is, a scanned document message is received and referenced by a user's inbox. When the user clicks on the scanned document message, the scanned document can be immediately presented to the user via a viewer. This is a departure from a model in which scanned documents are received as an attachment to an email. In this embodiment, the scanned document is the message and is not an attachment.

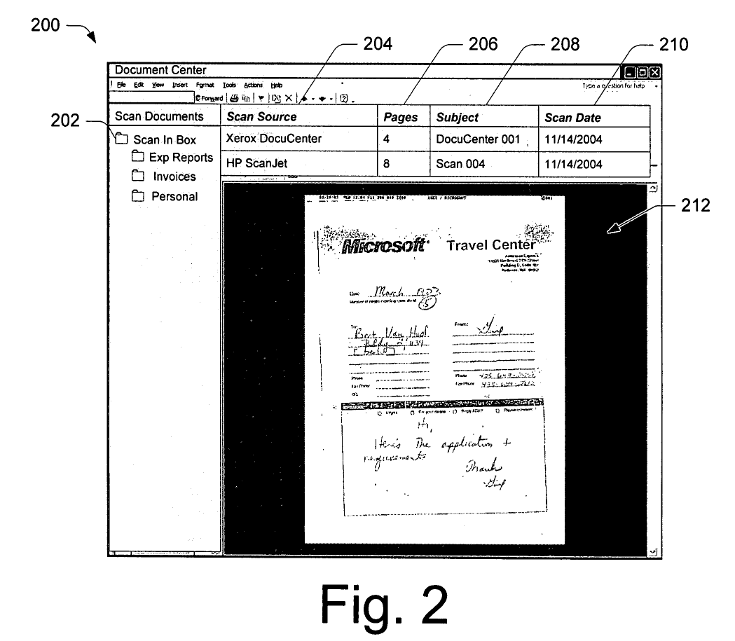

As an example, consider FIG. 2 which illustrates, generally at 200, an exemplary digital destination in accordance with one embodiment. In this example, the digital destination comprises a scan inbox which is similar in look and feel to an email inbox. In this example, a number of folders 202 are provided to assist the user in managing and organizing their received scan documents. In addition, in this particular example, a number of fields are provided including a scan source field 204 that indicates the source of a scanned document, a pages field 206 that indicates the number of pages in a scanned document, a subject field 208 that indicates the subject of a scanned document, and a scan date field 210 that indicates the date a document was scanned. The scanned documents in a particular folder can be sorted by field, as by the user clicking on a particular field. So, for example, if the user wishes to view the most recently-received documents, he or she can simply click on the scan date field 210. Likewise, if the user wishes to sort by scan source, he or she can simply click on the scan source field 204.

In addition, a presentation or preview window 212 is provided and enables a user to preview individual scanned documents in their inbox. In this particular example, the user has selected an individual scanned document and is viewing the first page.

With regard to authentication component 104 (FIG. 1), consider the following. In at least some embodiments, authentication component 104 is provided for authenticating users to the system. Authentication can take place in any suitable manner. For example, a user can authenticate using a scan card, RFID badge, a password, a fingerprint pad, retinal scan, digital ID card (e.g. an ICAO compliant electronic passport), and the like. Once authenticated to the scan device or scan system, the user may have a default profile that indicates the destination to which the scanned documents are to be sent, such as the user's inbox. In this regard, once the user is authenticated to the system, the system automatically knows the default destination. As such, the system can automatically send a scanned document to that destination, after the document is placed on a platen or document feeder and scanning is initiated by the user. As such, in at least some embodiments, after authentication and scan initiation, receiving a scanned document can be as easy as single user action, such as a one-click operation or single button push.

With regard to profiles 106, consider the following. In at least some embodiments, a user or a scan device can have one or more profiles for selection by the user. The profiles can indicate one or more destinations, as well as processing instructions that may be pertinent to a particular destination or particular users For example, once a scanned document is acquired, a user may wish to carry out some post-processing operations on the document (e.g., perform optical character recognition on the document). In these scenarios, more often than not a user will wish to perform more than one post-processing operation on the document (e.g., perform optical character recognition on the document, then add some information to the document, extract some image information from the document, extract contents, upload the extracted data to a database and then to finally archive it or forward it via e-mail or forward it as a fax).

In essence then, post-processing operations and associated instructions can include those that pertain to document processing operations as well as document routing operations. In majority of the cases document processing occurs before document routing.

In addition, a user may have a number of profiles that indicate destinations to which the user normally sends documents. Specifically, the user may designate one or more recipients in any particular profile and then, instead of having to select the recipient(s), the user simply selects the profile. Alternately or additionally, the scan device itself may be configured with one or more profiles that indicate one or more destinations. For example, in a small company with only three or four departments, the scan device may be configured with profiles for each department. As an example, consider the following. Assume a user works for a company that requires expense reports to be submitted to the accounting department for things such as expenses incurred on business trips. In this context, the company may have a digital copier/scanner with a profile for the accounting department. In this case, when the user returns from a business trip, he or she simply places their receipts and possibly a user identifier on the copier's platen, selects the appropriate profile, and in a single operation sends a scanned copy of the receipts to the accounting department. The scanned document can be tagged with appropriate metadata to identify the scan. In addition, the user may have a profile that includes both the accounting department and his or her inbox so that the user can receive and retain a copy of the receipts.

In addition, users and system administrators can create scan profiles using, for example, a suitable wizard. In addition, using a suitable scan wizard, users can also create scan job tickets (job tickets are described below in more detail). Job tickets are used to control scan quality aspects and document routing, distribution and archival for one specific scan job (this includes batch scans). Users can layer job tickets on top of existing scan profiles and override only individual settings for one specific job. The user can select from his or her collection of job tickets at the device to turn a sophisticated scan job into a simple single button operation. A scan job ticket is automatically removed after it successfully executed. As noted above, job tickets in the context of one particular embodiment are described below.

Multi-Function Integration

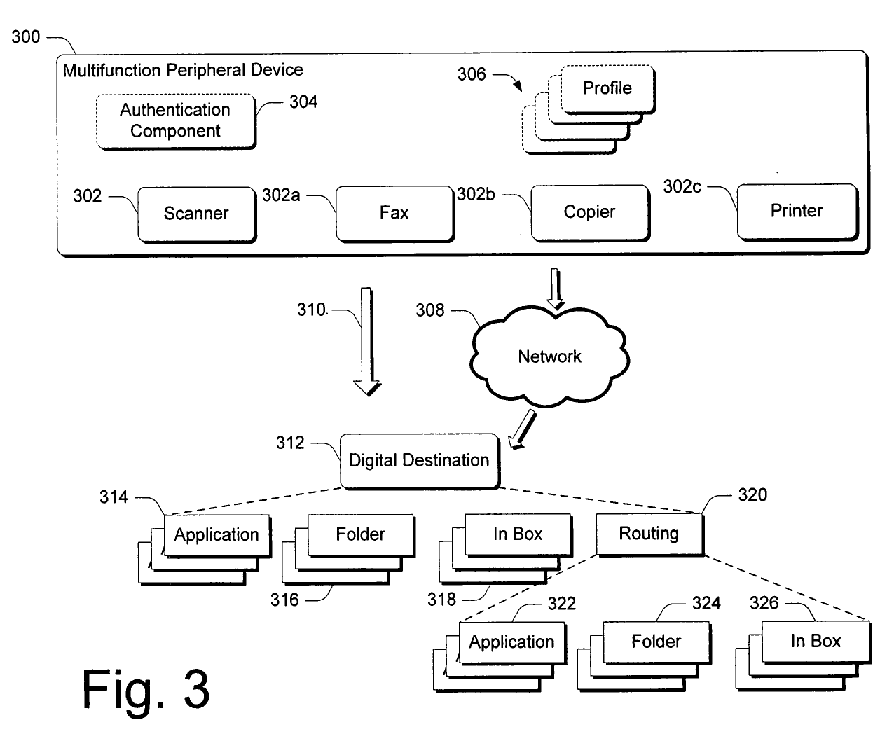

As an example of how the above-described scan functionality can be integrated with other functions, consider FIG. 3 which illustrates an exemplary multifunction peripheral device 300 in accordance with one embodiment. In this example, like numerals from the FIG. 1 example have been utilized where appropriate to indicate like components, except that the “3XX” notation is used. In addition, differences from the FIG. 1 example are indicated by the suffix “a”, “b” and “c”.

In this example, multifunction peripheral device 300 includes, in addition to scanner 302, one or more of a fax device 302a, a copier 302b, or a printer 302c. In at least some embodiments, the fax device and its associated functionality can operate in a manner similar to that of the scanner by providing faxed documents to a digital destination such as the ones described above.

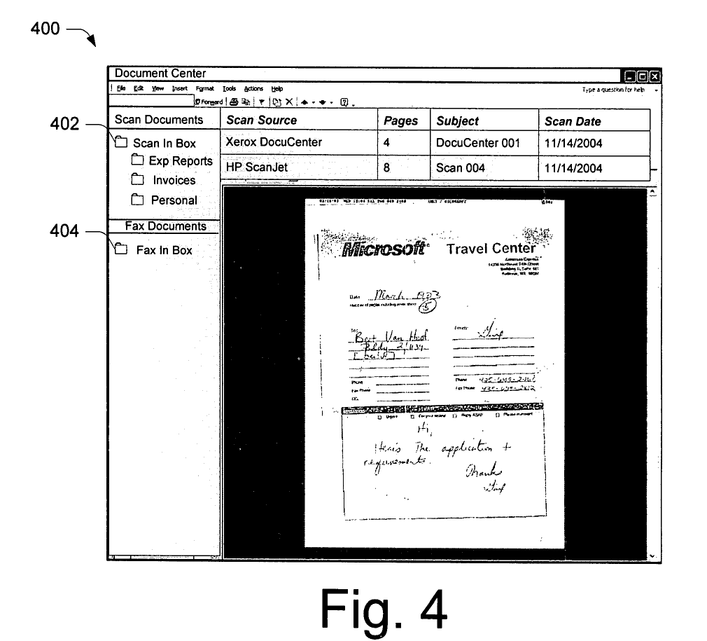

By integrating multiple functions together, as in this example, the user can be provided with an integrated, unified experience insofar as sending and receiving documents. As an example of an integrated, unified document receiving experience, consider FIG. 4 which illustrates, generally at 400, an exemplary digital destination in accordance with one embodiment. In this example, the digital destination comprises an inbox, with both scan and fax functionality, which is similar in look and feel to an email inbox. In fact, in this example, email functionality can be provided as well to give the user an even more unified and integrated experience.

In this example, a number of folders 402, 404 are provided to assist the user in managing and organizing their received scan and fax documents respectively. In addition, in this particular example, a number of fields are provided including a scan source field that indicates the source of a scanned document, a pages field that indicates the number of pages in a scanned document, a subject field that indicates the subject of a scanned document, and a scan date field that indicates the date a document was scanned. Similar fields can be provided for the fax and email functionality.

In addition, as in the FIG. 2 example, a presentation or preview window is provided and enables a user to preview individual scanned documents, faxed documents, and in at least some embodiment, email messages in their inbox.

### IMPLEMENTATION EXAMPLE

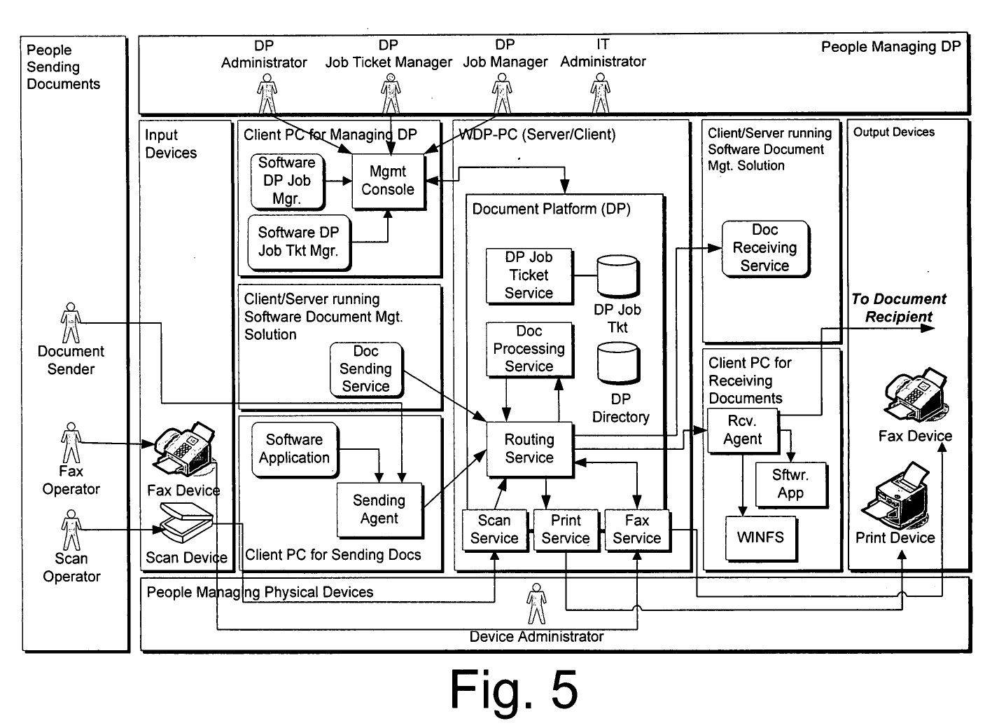

The above-described embodiments can be employed in connection with any suitable system. FIG. 5 illustrates one such system. It is to be appreciated and understood that the example of FIG. 5 is not intended to be used to limit application of the claimed subject matter. Rather, other systems can be utilized without departing from the spirit and scope of the claimed subject matter. As such, FIG. 5 constitutes but one example.

Prior to describing the system of FIG. 5, consider the following terms and definitions which will be used throughout the example below.

In the description that follows, there are a number of actors that are involved. These actors include Document Platform (DP) Services, Document Platform Clients, People, Devices, and Abstract Entities (i.e. a Person or Software), each of which is discussed under it own heading.

Document Platform (DP) Services

A Document Platform (DP) Service is a process within DP that provides a special service to a DP-CLIENT or another DP-SERVICE. A DP-SERVICE can be scanning by SCAN-SERVICE, document processing by DOCUMENT-PROCESSING-SERVICE, routing documents by the ROUTING-SERVICE or job ticket processing done by DP-JOB-TICKET-SERVICE.

A SCAN-SERVICE is a service that handles all communication with all SCAN-DEVICEs. It communicates with the SCAN-DEVICE to send SCAN-JOB-TICKETs and receive SCANNED-DOCUMENTs. The SCAN-SERVICE encapsulates a received SCAN-IMAGE in a DOCUMENT, together with one or more ROUTING-TICKETs (sent by scanner or populated by SCAN-SERVICE) and other metadata. The SCAN-SERVICE passes the DOCUMENT to the ROUTING-SERVICE which delivers it to the destinations identified in the individual ROUTING-TICKET(s).

A DOCUMENT-PROCESSING-SER VICE is a pluggable infrastructure consisting of DOCUMENT-PROCESSING-SERVICE-PLUG-INs. It receives a SCANNED-DOCUMENT from the ROUTING-SERVICE, performs the required processing tasks and passes it back to the ROUTING-SERVICE for delivery to the next destination.

A ROUTING-SERVICE is a service that receives a DOCUMENT and routes it based on the routing information in the ROUTING-TICKET to a ROUTING-DESTINATION.

A DP-JOB-TICKET-SER VICE is a service that stores DP-JOB-TICKETs.

Document Platform Clients

A DP-CLIENT is any software process that can interact with DP using DP-API to receive services from DP-SERVICES.

A RECEIVING-AGENT is an entity that receives DOCUMENTs and

NOTIFICATIONs from the ROUTING-SERVICE on behalf of a DOCUMENT-RECIPIENT on a PC.

A SENDING-AGENT is an entity that sends DOCUMENTs to ROUTING-SERVICE on behalf of a ROUTING-ORIGIN on a PC.

A SOFTWARE-APPLICATION is a user application such as Word®, Publisher, a portable document viewer such as Adobe Acrobat, and the like, that can receive and process DOCUMENTs.

A DOCUMENT-RECEIVING-SERVICE refers to a service that is capable of receiving DOCUMENTs from DP. Services such as Sharepoint®, Outlook®, Windows Document Library, and WINFS are examples of a DOCUMENT-RECEIVING-SERVICE.

A DOCUMENT-SENDING-SER VICE refers to a service that is capable of sending DOCUMENTs to ROUTING-DESTINATIONs via DP.

A MANAGEMENT-CONSOLE is a console provided for administration of DP and its components.

DP-DEVICE-SETUP-SOFTWARE refers to a DP setup program for installation of SCAN-DEVICE.

People

A SCAN-OPERATOR refers to a person who interacts with the scanner. The individual authenticates to the device, selects the appropriate SCAN-JOB-TICKET, performs any required modifications at the device and starts the SCAN-JOB.

An IT-ADMINISTRATOR manages connectivity between network and device as well as general network infrastructure. IT-ADMINISTRATORs also manage SCAN-DEVICES and SCAN-DEVICE-SECURITY-SETTINGs.

A DP-ADMINISTRATOR manages general DP infrastructure, a sub-set of tasks the IT-ADMINISTRATOR is authorized to manage.

A SCAN-DEVICE-ADMINISTRATOR manages the GLOBAL-SCAN-DEVICE-SETTINGS, settings that would affect all users of that SCAN-DEVICE (e.g. what type of TIFF file is produced). A SCAN-DEVICE-ADMINISTRATOR has the ability to limit access to scan features of a specific SCAN-DEVICE and/or require authorization before a SCAN-OPERATOR can access those features. A SCAN-DEVICE-ADMINISTRATOR sets these setting on the device itself, either at the physical device or by using a device specific management tool (created and distributed by the vendor of the SCAN-DEVICE).

An INFORMATION-WORKER is a person who receives and consumes information generated by the DP.

A HOME-SCAN-USER is a person that typically fills in the roles of the IT-ADMINISTRATOR, DEVICE-ADMINISTRATOR, SCAN-OPERATOR, DP-JOB-TICKET-MANAGER and DP-JOB-MANAGER in the home environment. The overall mindset, experience, technical depth and expertise of this actor is however very different than those found with the specialized people fulfilling these tasks.

A HOME-PC-USER refers to a home user of a personal computer.

A DOCUMENT-RECIPIENT refers to a person who is the final receiver of a document.

A DOCUMENT-SENDER is a person who sends a document.

Devices

A SCAN-DEVICE is a device capable of scanning a HARDCOPY-DOCUMENT. This can be a standalone scanner or a multi-function device (MFD)—also known as All-in-One (AiO) or Multi-function Peripheral (MFP). Digital copiers fall in the latter category. Devices can further be broken into Enterprise and Home categories.

ENTERPRISE-SCAN-DEVICEs can include different types of SCAN-DEVICES. For example, a NETWORKED-ENTERPRISE-SCAN-DEVICE is a Legacy network scanner (e.g., a Digital Copier, MFPs) that cannot be automatically discovered. A WSD-ENTERPRISE-SCAN-DEVICE is a Web Services-enabled network devices which allow for automatic discovery of the device. A DISCOVERABLE-ENTERPRISE-SCAN-DEVICE is a device that is discoverable using vendor provided protocols and software.

HOME-SCAN-DEVICEs can include different types of devices as well. For example, a LOCAL-HOME-SCAN-DEVICE is a SCAN-DEVICE that can be, for example, a local USB device. A SHARED-HOME-SCAN-DEVICE is a local device and a computer or PC that has the device installed and which acts as a network device to the rest of the computers or PCs on the network. A NETWORKED-HOME-SCAN-DEVICE is a legacy network scanner without automatic discovery. A WSD-HOME-SCAN-DEVICE is a Web Services-enabled Network Scanner. DISCOVERABLE-HOME-SCAN-DEVICEs refer to devices that are discoverable using vendor provided protocols and software.

Devices can also include a DP-PC, which is a computer, such as a PC, on which the DP is deployed.

Abstract (Person or Software)

A ROUTING-DESTINATION is a receiver of a DOCUMENT. It is a SOFTWARE-APPLICATION, a DOCUMENT-RECEIVING-SERVICE or a DOCUMENT-RECIPIENT.

A ROUTING-ORIGIN is the sender of a DOCUMENT. It is a SOFTWARE-APPLICATION, a DOCUMENT-RECEIVING-SERVICE or a person.

The DP-JOB-MANAGER is an entity (person or service) that monitors jobs within the system. This entity also manages jobs (e.g., deleting them or, potentially changing attributes). A DP-JOB-MANAGER can be an APPLICATION, or any of the people actors described above. A JOB can be a SCAN-JOB.

The DP-JOB-TICKET-MANAGER is an entity that creates and manages DP-JOB-TICKETs. A DP-JOB-TICKET-MANAGER can be a SOFTWARE-APPLICATION, or any of the people actors described above.

A DP-JOB-INITIATOR is an entity (person or service) that initiates a DP-JOB within the system. This entity can be a SCAN-OPERATOR, INFORMATION-WORKER or SCAN-DEVICE. The SOFTWARE-APPLICATIONs and DOCUMENT-RECEIVING-SERVICES start DP-JOBS on behalf of a person.

Consider now some Document Platform Terminology. The terminology can be categorized into six categories as follows: Document Platform (DP) and its components, Tickets, Tasks, Jobs, Document Specific Terms, and Scan Specific Terms, each of which is discussed under its own heading below.

Document Platform (DP) and its Components

The Document Platform (DP) enables capture, processing and routing of DOCUMENTs. Capture can cover a wide variety of sources, but focus in this document is on capturing DOCUMENTs via a SCAN-DEVICE. In this case the DP enables capturing a digital copy of one or more pages of a printed DOCUMENT via a SCAN-DEVICE, applying further image processing on those captured DOCUMENTs and finally routing those processed pages as a single DOCUMENT to one or more specified destinations on the PC or the network.

The DP includes a SCAN-SERVICE, a ROUTING-SERVICE and a DOCUMENT-PROCESSING-SERVICE. All three components execute on a single PC. These components can, however, be distributed across different PCs.

The platform enables discovery, installation and setup of SCAN-DEVICEs. It also allows the creation and management of DEVICE-USAGE-POLICIES and the creation and management of SCAN-OPERATORs. Reusable collections of pre-determined SCAN-JOB-TICKETs can be associated with individual SCAN-OPERATORs or SCAN-OPERATOR-GROUPs.

The DP-API provides programmatic capability for using, managing and monitoring its components.

DP capture covers device-initiated (push) scan scenarios, as well as pull scenanos.

DOCUMENT-PROCESSING-SER VICE-PLUG-Ins are document processing components such as Optical Character Recognition (OCR), Digital Rights Management (DRM) or File Conversion that can be plugged into the DOCUMENT-PROCESSING-SERVICE.

The DP-API refers to a set of APIs that provide programmatic access to the DP's components.

DP-USERS are registered users of the Document Platform.

The DP-DIRECTORY is a directory containing the ENTERPRISE-SCAN-DEVICE identification, credentials, SCAN-DEVICE-CAPABILITES, SCAN-DEVICE-POLICY and SCAN-OPERATOR information are stored.

DP-NOTIFICATIONs contain the status of a ROUTING-JOB communicated to a ROUTING-DESTINATION. A NOTIFICATION can be of the following types. An ERROR-NOTIFICATION indicates that there was an error performing the job. This type of notification contains the description of the error and steps needed to recover if possible. A SUCCESS-NOTIFICATION is a delivery receipt (to the job initiator or another user) communicating that the DOCUMENT was successfully routed to its ROUTING-DESTINATION. This notification communicates the job parameters for identification. A DOCUMENT-ARRIVAL-NOTIFICATION is used to let the RECEIVING-AGENT know that that a DOCUMENT has arrived at that destination and needs to be received. There can be actions registered for this type of NOTIFICATION so they can be activated upon arrival of a document (e.g. automatically received by a SOFTWARE-APPLICATION). A STATUS-NOTIFICATION communicates the current status of a job if requested.

Tickets

A ticket is an XML description of the desired outcome of a service request to DP and DP-SERVICEs.

A DP-JOB-TICKET is an XML description containing a set of elements that describe the desired outcome of a DP-JOB. Sub-components can be a SCAN-TICKET, a ROUTING-TICKET, a DOCUMENT-PROCESSING-TICKET, a FAX-TICKET and a PRINT-TICKET. For example, a ‘Copy’ job can be created by combining and specifying a scan and print ticket in the job ticket, with potentially a document processing ticket in the middle, if operations such as scaling are to be performed.

A SCAN-JOB-TICKET is a DP-JOB-TICKET that contains a SCAN-TICKET and in which clearly the scan is the foundation activity for this job.

A SCAN-TICKET is an XML description of parameters to be used to set up the SCAN-DEVICE for one specific Scan Job.

A ROUTING-TICKET is an XML description of instructions for the ROUTING-SERVICE.

A DOCUMENT-PROCESSING-TICKET is an XML description of instructions for the DOCUMENT-PROCESSING-SERVICE.

A PRINT-TICKET is an XML description of instructions for the ROUTING-SERVICE.

A FAX-TICKET is an XML description of instructions for the ROUTING-SERVICE. This includes both send and receive fax operations.

Tasks

A TASK is a unit of operation performed by a DP-SERVICE.

A DOCUMENT-PROCESSING-TASK is a unit of operation provided by the DOCUMENT-PROCESSING-SERVICE.

A SCAN-TASK is a unit of operation provided by the SCAN-DEVICE that transforms a physical DOCUMENT into an electronic rendition and delivers the electronic rendition to the SCAN-SERVICE.

A ROUTING-TASK is a unit of operation provided by the SCAN-SERVICE (or a RECEIVING-AGENT-APPLICATION) to the ROUTING-SERVICE.

Jobs

A job is an entity containing all tasks that need to be performed when a service is requested from DP and DP-SERVICES. A service is requested from DP by invoking a DP-TICKET or using a DP-API. A DP-JOB, therefore, is an instantiation of a DP-JOB-TICKET.

A SCAN-JOB comprises everything that happens from when the SCAN-OPERATOR hits the scan button until the final end-result of that action is accomplished. A SCAN-JOB job is invoked by a SCAN-OPERATOR, and involves a SCAN-TASK, and—optionally—a ROUTING-TASK a DOCUMENT-PROCESSING-TASK, FAX-TASK and PRINT-TASK.

A DOCUMENT-PROCESSING-JOB comprises everything that happens from when a DP-CLIENT requests a service by DOCUMENT-PROCESSING-SERVICE until the final end-result of that action is accomplished.

A ROUTING-JOB comprises everything that happens from when a DP-CLIENT requests a service by ROUTING-SERVICE till the final end-result of that action is accomplished.

Document Specific Terms

A DOCUMENT contains the DOCUMENT-IMAGE (e.g., a word file, a tiff file, etc) plus all its properties (DOCUMENT-IMAGE-METADATA) and information about the job that needs to be performed on this DOCUMENT (DP-JOB-TICKET).

A DOCUMENT-IMAGE refers to the body of the DOCUMENT.

DOCUMENT-IMAGE-METADATA describes the properties of the DOCUMENT.

A HARDCOPY-DOCUMENT refers to a paper document.

A SCANNED-DOCUMENT is a document that arrives at SCAN-SERVICE from the SCAN-DEVICE.

Scan Specific Terms

SCAN-DEVICE-CAPABILITIES is a comprehensive and complete XML description of all capabilities of a SCAN-DEVICE. SCAN-DEVICE-CAPABILITIES can be part of the Device Control Protocol (DCP) within Web Services for Devices (WSD). SCAN-DEVICE-CAPABILITES are stored in the DP-DEVICE-DIRECTORY in DP and leveraged for building SCAN-TICKETS.

SCAN-DEVICE-POLICY refers to global policies set in a company on usage of a SCAN-DEVICE. For example a SCAN-DEVICE can only be used by one domain user only or used by a group of domain users only. For example, a SCAN-DEVICE at a company copy room can only be used by group “engineering”.

Having now described various terms and definitions, consider now a number of so-called “use cases” that describe different scenarios of how the above-described system can be used. Each use case is described under its own separate heading.

Install Device and Connect

This section provides the use cases for installation of a SCAN-DEVICE. In the discussion that follows, the following sub-sections appear: Enterprise Device Install, Assign Device Policy, Enterprise Publish Device, Enterprise Share Device, Enterprise Device Un-install, and Home Device Install. Throughout the discussion below, reference should be made to FIG. 5.

Enterprise Device Install

In this section, the main actor is the DP-ADMINISTRATOR. The environment can include a small organization (SORG) (e.g., 1-99 employees), medium sized organization (MORG) (e.g. 100-999 employees) or an Enterprise (e.g. 1000+ employees) with a managed network. Here, ENTERPRISE-SCAN-DEVICEs are added to the DP-DIRECTORY along with their identification, credentials and the SCAN-DEVICE-CAPABILITES. The install is done on the DP-PC. The ENTERPRISE-SCAN-DEVICE software is not installed on INFORMATION-WORKER's PC. Installation of vendor software for the purpose of creating a richer user experience is possible but is not described in this use case.

A post-condition in this case is that the ENTERPRISE-SCAN-DEVICE is installed on the DP-PC and is added to the DP-DIRECTORY.

In this use case, the DP-ADMINISTRATOR plugs the (wired) ENTERPRISE-SCAN-DEVICE in the network. In case the ENTERPRISE-SCAN-DEVICE is a wireless device the DP-ADMINISTRATOR follows the instructions provided by the ENTERPRISE-SCAN-DEVICE manufacturer to bring the device online. An IP address is assigned to the ENTERPRISE-SCAN-DEVICE: the IP address is either automatically acquired by the ENTERPRISE-SCAN-DEVICE or it is physically assigned by the DP-ADMINISTRATOR at the SCAN-DEVICE.

The DP-ADMINISTRATOR secures the ENTERPRISE-SCAN-DEVICE by setting up network transport security and storing the ENTERPRISE-SCAN-DEVICE credentials like an encryption key and other security parameters.

The DP-ADMINISTRATOR installs the ENTERPRISE-SCAN-DEVICE on the DP PC. For NETWORKED-ENTERPRISE-SCAN-DEVICEs and DISCOVERABLE-ENTERPRISE-SCAN-DEVICEs, the DP-ADMINISTRATOR runs the DP-DEVICE-SETUP-SOFTWARE. For WSD-ENTERPRISE-SCAN-DEVICEs the DP-ADMINISTRATOR, triggered by a plug and play event, agrees to install the device on the DP-PC and the DP-DEVICE-SETUP-SOFTWARE is automatically launched.

If the driver for the ENTERPRISE-SCAN-DEVICE is not part of the OS installation, the DP-DEVICE-SETUP-SOFTWARE invokes the standard OS prompt for locating a missing driver. It asks the DP-ADMINISTRATOR to provide the vendor setup program (CD, URL, network location, etc) and runs the vendor setup program for the NETWORKED-ENTERPRISE-SCAN-DEVICE. If the driver is part of the OS installation, it is installed by the DP-DEVICE-SETUP-SOFTWARE. The setup process is broken into three steps to find and identify the ENTERPRISE-SCAN-DEVICE and install the appropriate driver and software:

Find the ENTERPRISE-SCAN-DEVICE

For NETWORKED-ENTERPRISE-SCAN-DEVICE, this step is done manually. The DP-ADMINISTRATOR is prompted to enter NETWORKED-ENTERPRISE-SCAN-DEVICE's IP address. The DP-ADMINISTRATOR finds and enters the IP address assigned to the NETWORKED-ENTERPRISE-SCAN-DEVICE. The IP address can be obtained from the NETWORKED-ENTERPRISE-SCAN-DEVICE (e.g. print out) or from the IT infrastructure (provided by the IT-ADMINISTRATOR).

WSD-ENTERPRISE-SCAN-DEVICE and DISCOVERABLE-ENTERPRISE-SCAN-DEVICE are automatically discovered by DP-DEVICE-SETUP-SOFTWARE. In case of DISCOVERABLE-ENTERPRISE-SCAN-DEVICEs this is accomplished via the setup software supplied by the DISCOVERABLE-ENTERPRISE-SCAN-DEVICE vendor.

Identify the ENTERPRISE-SCAN-DEVICE

This step finds out the ENTERPRISE-SCAN-DEVICE name, model and its ENTERPRISE-SCAN-DEVICE-CAPABILITIES. The information will be used in determining the vendor software that needs to be installed. The information is also added to the DP-DIRECTORY for the ENTERPRISE-SCAN-DEVICE.

For NETWORKED-ENTERPRISE-SCAN-DEVICEs this step is done manually. The DP-DEVICE-SETUP-SOFTWARE (vendor setup) prompts the DP-ADMINISTRATOR to enter the NETWORKED-ENTERPRISE-SCAN-DEVICE's identity, which includes the name and model of the NETWORKED-ENTERPRISE-SCAN-DEVICE.

For WSD-ENTERPRISE-SCAN-DEVICEs and DISCOVERABLE-ENTERPRISE-SCAN-DEVICEs identity and the SCAN-DEVICE-CAPABILITES are automatically discovered by the DP-DEVICE-SETUP-SOFTWARE.

Install Software

This step includes installing drivers and any additional plug-ins that are required for the ENTERPRISE-SCAN-DEVICE to function or to enhance the device user experience.

If the software is part of the OS installation, it automatically gets installed. Otherwise the DP-DEVICE-SETUP-SOFTWARE asks the DP-ADMINISTRATOR to locate the software to be installed (e.g., insert a vendor CD, provide a network path, vendor URL, etc). The software is then installed by DP-DEVICE-SETUP-SOFTWARE.

At this point, DP-DEVICE-SETUP-SOFTWARE is finished. The DP-ADMINISTRATOR is allowed to set SCAN-DEVICE-POLICY, share or publish the ENTERPRISE-SCAN-DEVICE. These use cases are described below. At this point the ENTERPRISE-SCAN-DEVICE is added to the DP-DIRECTORY and is ready to be used.

Assign Device Policy

In this use case, the main actor is the DP-ADMINISTRATOR, and the environment is: SORG, MORG or Enterprise. A pre-condition is that the SCAN-DEVICE has been installed. ENTERPRISE-SCAN-DEVICE is in DP-DIRECTORY.

In this example, the DP-ADMINISTRATOR assigns SCAN-DEVICE-POLICY to ENTERPRISE-SCAN-DEVICE in the DP-DIRECTORY. DP-USERs are assigned to the ENTERPRISE-SCAN-DEVICE in this step. For example, the ‘Engineering’ team might be assigned to the ENTERPRISE-SCAN-DEVICE that was installed. This step can be done at any point after install using the MANAGEMENT-CONSOLE.

Enterprise Publish Device

In this use case, the main actor is the DP-ADMINISTRATOR and the environment is: SORG, MORG or Enterprise with a Managed Network and Directory. A pre-condition is that the SCAN-DEVICE has been installed. ENTERPRISE-SCAN-DEVICE is in DP-DIRECTORY.

At the end of the install process, the DP-ADMINISTRATOR gets prompted if he wants to publish the ENTERPRISE-SCAN-DEVICE. A published ENTERPRISE-SCAN-DEVICE is added to the corporate directory through which corporate users can discover ENTERPRISE-SCAN-DEVICEs available to them.

The DP-ADMINISTRATOR can opt to publish the ENTERPRISE-SCAN-DEVICE. The device information is published to the corporate directory and is available for use. The SCAN-DEVICE-POLICY determines the scope of allowed use.

The DP-ADMINISTRATOR can also opt not to publish the ENTERPRISE-SCAN-DEVICE. The device is not published and is only accessible to DP-USERS. The DP-ADMINISTRATOR can publish the ENTERPRISE-SCAN-DEVICE using the MANAGEMENT-CONSOLE at a later time.

Enterprise Share Device

In this use case, the main actor is the DP-ADMINISTRATOR and the environment is: SORG, MORG or Enterprise. A pre-condition is that the ENTERPRISE-SCAN-DEVICE has been installed and the ENTERPRISE-SCAN-DEVICE is in DP-DIRECTORY. A corporate directory is not used here. Sharing can be done both in managed and un-managed network with or without a directory service that provides the means to manage the identities and relationships that make up the network environment. In a managed network, the DP-ADMINISTRATOR can choose to share the ENTERPRISE-SCAN-DEVICE but not publish it.

The DP-ADMINISTRATOR can share the SCAN-DEVICE through the MANAGEMENT-CONSOLE to a user, a group of users, or entire company. After this step, the SCAN-DEVICE is available for browse and use by whomever it was shared to.

After sharing a device, the DP-ADMINISTRATOR can assign SCAN-DEVICE-POLICY to DP-DIRECTORY for the ENTERPRISE-SCAN-DEVICE. The DP-USERs are assigned to the ENTERPRISE-SCAN-DEVICE in this step. This step can be done at any point after install described in Manage use cases below.

Enterprise Device Un-Install

In this use case, the main actor is the DP-ADMINISTRATOR and the environment is: SORG, MORG or Enterprise with a Managed Network. ENTERPRISE-SCAN-DEVICES are in a managed DP-DIRECTORY.

The DP Administrator can remove the ENTERPRISE-SCAN-DEVICE from DP. All references to the ENTERPRISE-SCAN-DEVICE are removed from DP-DIRECTORY. If the device is a published device, the ENTERPRISE-SCAN-DEVICE is removed from corporate directory (un-publish the device).

Uninstalling the device software can be accomplished in three steps: 1) to remove all drivers on DP-PC, 2) cleanup the configurations settings repository on the DP-PC and 3) remove all vendor software applications associated with the SCAN-DEVICE. The DP-ADMINISTRATOR gets a choice of doing one or all of the above removal tasks.

Home Device Install

In this use case, the main actor is the HOME-PC-USER and the environment is the HOME. The HOME-SCAN-DEVICE is installed on each desktop at home where the HOME-PC-USER needs to scan to. The HOME-SCAN-DEVICE information is stored in the DP-DIRECTORY of each desktop where it is installed.

The device can be plugged in and installed as follows. For LOCAL-HOME-SCAN-DEVICE, if there is an OS driver the software is installed. If there is no OS driver, the HOME-PC-USER is prompted to locate the software (vendor CD or vendor URL), after which the software is installed and the setup program exits.

For NETWORKED-HOME-SCAN-DEVICE, the HOME-PC-USER gets the IP address from the device (from device print out or display). The HOME-PC-USER runs the DP-DEVICE-SETUP-SOFTWARE and identifies the HOME-SCAN-DEVICE to install (type, model). If the device software is part of the OS installation, DP-DEVICE-SETUP-SOFTWARE installs the software and prompts the HOME-PC-USER enter the IP address for the device and finishes install. Otherwise, the HOME-PC-USER is prompted to provide the software (e.g. vendor CD). The vendor setup program is run; the HOME-PC-USER enters the HOME-SCAN-DEVICE IP address; and install completes.

For WSD-HOME-SCAN-DEVICE and DISCOVERABLE-HOME-SCAN-DEVICE the device is automatically discovered and identified. The HOME-PC-USER is prompted to agree to install and if so the HOME-SCAN-DEVICE is installed. If the driver for the Device is part of the OS installation then it is installed. Otherwise, the HOME-PC-USER is prompted to provide the driver (e.g. vendor CD). If there are additional instructions from vendor on installation of more software applications, the HOME-PC-USER will have to follow those steps and complete the install.

For SHARED-HOME-SCAN-DEVICE, the SCAN-DEVICE and the PC where it is installed on, act as a network SCAN-DEVICE to the other PC at home.

Uninstalling the device and clean up the DP-PC gives the HOME-PC-USER the option to 1) remove the drivers, 2) remove all vendor software and 3) clean up the PC configurations settings repository.

Authenticate

This section provides the use case for various authentications that can be utilized, including authentication to the SCAN-DEVICE and authentication to the DOCUMENT-IMAGING-PLATFORM and its components. In this section, the following sub-sections are used: Enterprise Authenticate to Device, Enterprise Authentication to Management Console, User Authentication to Management Console, Application Authentication to DP, Enterprise Document Service Authentication to DP, Enterprise Routing Service Authenticates to Document, Enterprise Device Authenticates to Scan Service, and Home Authentication.

Enterprise Authenticate to Device

In this case, the main actor is the SCAN-OPERATOR. The environment is SORG, MORG or Enterprise with a Managed Network. The SCAN-OPERATOR is required to authenticate only if an authentication mechanism is present on the ENTERPRISE-SCAN-DEVICE. Otherwise, this step is skipped. If there is no SCAN-OPERATOR identification or authentication done on the ENTERPRISE-SCAN-DEVICE, at the SCAN-SERVICE a default SCAN-OPERATOR can be associated with the SCAN-TICKET used by the ENTERPRISE-SCAN-DEVICE for this scan. This is only possible if the DP-ADMINISTRATOR allows installation and usage of such a device in the corporation. Perhaps the ENTERPRISE-SCAN-DEVICE can be used while the Usage Policy set on it only allows limited use like Scan to Email only. The IT-ADMINISTRATOR is expected to secure their network as they see fit.

Authentication to the device can work in the following way. The SCAN-OPERATOR walks to the device and authenticates (logs on) to the device. The SCAN-OPERATOR can authenticate with the following roles and methods:

Roles:
Logging as ANONYMOUS-USER will set the DP-JOB-INITIATOR to ANONYMOUS-USER. The SCAN-OPERATOR can browse the DP-JOB-TICKETs associated with an ANONYMOUS-USER on the ENTERPRISE-SCAN-DEVICE.
Authenticate as self. The DP-JOB-INITIATOR is the SCAN-OPERATOR.
Authenticate on behalf of another user. The DP-JOB-INITIATOR will be the SCAN-OPERATOR but he will be able to browse the delegating user's DP-JOB-TICKETs. The SCAN-OPERATOR must have access to authenticate on behalf of the other DP-USER.
Authenticate as a member of a group like ‘Engineering’. DP-JOB-INITIATOR will be the SCAN-OPERATOR but he has to access to all ‘Engineering’ DP-JOB-TICKETs.

Methods:
SCAN-OPERATOR can use a Smart Card to authenticate him to the domain
SCAN-OPERATOR enters his domain Username/password at a keypad on the ENTERPRISE-SCAN-DEVICE
SCAN-OPERATOR enters a ENTERPRISE-SCAN-DEVICE pin which allows authentication to the ENTERPRISE-SCAN-DEVICE only
SCAN-OPERATOR browses the user list on the ENTERPRISE-SCAN-DEVICE and selects one. No password is entered. SCAN-OPERATOR will see the DP-JOB-TICKETs associated with that user only. The DP-JOB-INITIATOR will be the username that was picked.
None: if there is no authentication system present or if the device allows for anonymous authentication. With regard to logging off from the ENTERPRISE-SCAN-DEVICE, the ENTERPRISE-SCAN-DEVICE can be configured so it logs off the SCAN-OPERATOR automatically after a certain period of inactivity.

Enterprise Authentication to Management Console

In this use case, the main actor is the DP-ADMINISTRATOR. The environment is SORG, MORG or Enterprise with a Managed Network. The DP-ADMINISTRATOR manages DP, ENTERPRISE-SCAN-DEVICE, DP-USERs, SCAN-DEVICE-POLICY, ROUTING-SERVICE and other DP components using the MANAGEMENT-CONSOLE. The DP-ADMINISTRATOR needs to authenticate to the MANAGEMENT-CONSOLE. The level of authorization dictates the management capabilities provided to the DP-ADMINISTRATOR by the MANAGEMENT-CONSOLE. In this example, the DP-ADMINISTRATOR authenticates to the MANAGEMENT-CONSOLE with username/password.

User Authentication to Management Console

In this use case, the main actor is the DP-JOB-TICKET-MANAGER. The environment is SORG, MORG or Enterprise with a Managed Network. The DP-JOB-TICKET-MANAGER authenticates to the MANAGEMENT-CONSOLE for management of his personal DP-JOB-TICKETs or public DP-JOB-TICKETS entrusted to him. The DP-JOB-TICKET-MANAGER can authenticate to the MANAGEMENT-CONSOLE with username/password for management of DP-JOB-TICKETS.

Application Authentication to DP

In this use case, the main actor is a SOFTWARE-APPLICATION. The environment is SORG, MORG or Enterprise with a Managed Network. SOFTWARE-APPLICATION authenticates to MANAGEMENT-CONSOLE for management of its DP-JOB-TICKETS. It has to authenticate to DP so it can receive DOCUMENTs from ROUTING-SERVICE of DP.

The SOFTWARE-APPLICATION authenticates to DP with SOFTWARE-APPLICATION credentials for management of DP-JOB-TICKETS. The SOFTWARE-APPLICATION registers to DP as a valid receiver of documents.

Enterprise Document Service Authentication to DP

In this use case, the main actor is DOCUMENT-RECEIVING-SERVICE. The environment is SORG, MORG or Enterprise with a Managed Network. DOCUMENT-RECEIVING-SERVICE authenticates itself to DP via APIs to use ROUTING-SERVICE. Using parameters in this API, it registers how it can receive DOCUMENTs from the ROUTING-SERVICE.

DOCUMENT-RECEIVING-SERVICE registers via DP-API to the ROUTING-SERVICE of DP as a valid receiver and sender of DOCUMENTs. DOCUMENT-RECEIVING-SERVICE has to provide some information using parameters of the DP-API on how it is to receive DOCUMENTs. This is the first step in establishing a trusted relationship between ROUTING-SERVICE and DOCUMENT-RECEIVING-SERVICE. The second step is communicated as described below.

Enterprise Routing Service Authenticates to Document Receiving Service

In this use case, the main actor is the ROUTING-SERVICE. The environment is SORG, MORG or Enterprise with a Managed Network.

ROUTING-SERVICE authenticates to the DOCUMENT-RECEIVING-SERVICE on behalf of sender so it can route the DOCUMENT to that service. Doing so, the second half of the trusted relationship between ROUTING AGENT and DOCUMENT-RECEIVING-SERVICE are established.

Enterprise Device Authenticates to Scan Service

In this use case, the main actor is the ENTERPRISE-SCAN-DEVICE. The environment is SORG, MORG or Enterprise. ENTERPRISE-SCAN-DEVICE authenticates itself to the SCAN-SERVICE so it can send documents to the SCAN-SERVICE and receive DP-JOB-TICKETs from it. Having the data transmission security could be a requirement by IT and therefore supported.

ENTERPRISE-SCAN-DEVICE authenticates to the SCAN-SERVICE by providing credential information. It can then transmit data to the SCAN-SERVICE securely using the credential stored on ENTERPRISE-SCAN-DEVICE. The ENTERPRISE-SCAN-DEVICE can digitally sign the document.

ENTERPRISE-SCAN-DEVICE authenticates to the SCAN-SERVICE on behalf of the SCAN-OPERATOR with SCAN-OPERATOR's credentials.

Home Authentication

The main actor in this use case is the HOME-PC-USER and the environment is the HOME. In this example, no authentication to DP is necessary in the home. Authentication to the HOME-SCAN-DEVICE can be provided by the HOME-SCAN-DEVICE vendor. If there is the capability provided on the HOME-SCAN-DEVICE to pick a SCAN-TICKET, the HOME-PC-USER will browse and select the SCAN-TICKET. There could be other vendor specific solutions for identification of the user and destination (PC) at the HOME-SCAN-DEVICE.

Capture Document

This section covers the use cases for scanning a document by a Scan User or a Home User. The user needs to setup the scanning device or scanner. This section has three subsections: Enterprise Capture (where the SCAN-OPERATOR is the actor), Home Capture, and Enterprise Capture (where the SCAN-SERVICE is the actor).

Enterprise Capture (SCAN-OPERATOR)

In this use case, the main actor is the SCAN-OPERATOR. The environment is SORG, MORG or Enterprise with a Managed Network. After authenticating to the ENTERPRISE-SCAN-DEVICE (if needed) the SCAN-OPERATOR sets up the scan attributes as outlined in this use case, scans, logs off, possibly wait for a notification and walks away from the ENTERPRISE-SCAN-DEVICE.

With regard to setting up the scan, consider the following. There are various ways the SCAN-OPERATOR sets up the scan attributes needed for scan.

The SCAN-OPERATOR can pick a SCAN-JOB-TICKET, modify it further (if allowed) or create a new SCAN-JOB-TICKET as follows:

Pick ticket. At the ENTERPRISE-SCAN-DEVICE the SCAN-OPERATOR browses the SCAN-JOB-TICKETs available to him and selects one.
Update ticket. If the SCAN-JOB-TICKET is modifiable, the SCAN-OPERATOR can change some of the attributes (which are modifiable) to create a new set of attributes for this scan only. If the SCAN-JOB-TICKET is writable, the SCAN-OPERATOR can save the new attributes back to the original SCAN-JOB-TICKET or save as a new SCAN-JOB-TICKET. The newly created SCAN-JOB-TICKET will not be pushed back to DP-JOB-TICKET-SERVICE for storage.
Ad-hoc: set scan attributes on the ENTERPRISE-SCAN-DEVICE using the device touchpad for one time only usage (if this functionality is provided by the Device).
Paper Cover Sheet: SCAN-OPERATOR uses a paper cover sheet that includes scan attributes and destination information to create the SCAN-JOB-TICKET. There are multiple possibilities on how this can be implemented. For example this sheet could be a Vendor provided Cover Sheet which is then interpreted by the ENTERPRISE-SCAN-DEVICE and a matching SCAN-JOB-TICKET is found or created and SCAN-JOB is created. Another Use Case is if Cover Sheet gets interpreted by the SCAN-SERVICE to calculate the routing information to be passed to the ROUTING-SERVICE. In either case, a standard needs to be set for the Cover Sheet one understood by the Device and one for the SCAN-SERVICE. Third category is to scan a Cover Sheet understood by the receiving DOCUMENT-RECEIVING-SERVICE.
Bar coded document: use a printed barcode on the HARDCOPY-DOCUMENT or the cover to indicate to the ENTERPRISE-SCAN-DEVICE the scan attributes and destination information. This is a similar case to the Paper Cover Sheet.
None (default SCAN-JOB-TICKET for the SCAN-OPERATOR will be used). The default SCAN-JOB-TICKET was set for this SCAN-OPERATOR (or the group he belongs to) by the DP-ADMINISTRATOR. If there is no default SCAN-JOB-TICKET for the SCAN-OPERATOR, the default SCAN-JOB-TICKET for the scan button will be used. If that is also not present, the scan is not possible and an error will be shown by the ENTERPRISE-SCAN-DEVICE after SCAN-OPERATOR tries to scan.

Having set up the scan, the SCAN-OPERATOR now hits “Scan”. The SCAN-OPERATOR has the option of canceling a scan in progress for whatever reason (e.g., ADF jammed, don't feel like scanning this anymore, etc). The ENTERPRISE-SCAN-DEVICE and the SCAN-SERVICE must discard the scanned document and not store it anywhere. The SCAN-OPERATOR does this in two ways: First, from the ENTERPRISE-SCAN-DEVICE where he can browse the SCAN-JOBs and cancel them; second, he can browse and cancel jobs from his PC via the MANAGEMENT-CONSOLE as explained in the “Manage” section below.

Post-scan, the SCAN-OPERATOR can save the SCAN-JOB-TICKET and get notifications from ENTERPRISE-SCAN-DEVICE on the status of the SCAN-JOB. Saving can be accomplished in a number of different ways:
Save SCAN-JOB-TICKET with the changes made if allowed (if it is writable).
Save as a new SCAN-JOB-TICKET with the changes made if user has rights to create a new SCAN-JOB-TICKET on the ENTERPRISE-SCAN-DEVICE. The resulting SCAN-JOB-TICKET will not be pushed back to the DP-JOB-TICKET-SERVICE for storage.
Get device notification of success or failure
A printout of the SCAN-JOB success with username, the time and size of job and success/failure status.
Display notification. On the ENTERPRISE-SCAN-DEVICE a dialog to show success or failure and an option given to the SCAN-OPERATOR on what to do in case of error.
A Delivery Receipt can be printed by the ENTERPRISE-SCAN-DEVICE (similar to the fax model) if the ENTERPRISE-SCAN-DEVICE has printing capabilities.

Note that DP-NOTIFICATIONS are sent from the ROUTING-SERVICE to other destinations like email if specified.

Home Capture

In this use case, the main actor is the HOME-SCAN-USER and the environment is the HOME. DP does address the Pull Scenarios. For Devices capable of push scenarios that can store SCAN-JOB-TICKETS, SCAN-JOB-TICKETS can be created and pushed down to the HOME-SCAN-DEVICE. The SCAN-OPERATOR can select the SCAN-JOB-TICKET and use it to scan. If the capability is not present on the HOME-SCAN-DEVICE, the HOME-SCAN-DEVICE can send the SCANNED-DOCUMENT to the SCAN-SERVICE of the DP-PC it is installed on. The SCAN-SERVICE associates the incoming job with a SCAN-JOB-TICKET for the HOME-PC-USER who is in session on the PC.

With regard to setting up the scan, consider the following. If provided by the HOME-SCAN-DEVICE, the HOME-SCAN-USER browses and selects a SCAN-JOB-TICKET assuming the HOME-SCAN-USER has already setup the SCAN-JOB-TICKET on his PC identifying ROUTING-DESTINATION and scan attributes. The HOME-SCAN-USER might have to browse other vendor-specific tickets and pick one; for example, the user might have to pick (on the HOME-SCAN-DEVICE) a PC as a final ROUTING-DESTINATION.

To initiate a scan from the HOME-SCAN-DEVICE, the HOME-SCAN-USER puts the HARDCOPY-DOCUMENT on the HOME-SCAN-DEVICE's ADF or glassplate and hits scan. If the HOME-SCAN-DEVICE offers multiple PCs as ROUTING-DESTINATIONs, the HOME-SCAN-USER picks one. Otherwise, a default PC (ROUTING-DESTINATION) is used.

On the desktop a document wizard (or any registered SOFTWARE-APPLICATION) is launched upon document arrival asking HOME-SCAN-USER what to do with it. The HOME-SCAN-USER is given the options to save or 2 process the document. If the HOME-SCAN-USER selects to ‘save the document’, 3 the HOME-SCAN-USER gets an option to ‘save as’ to a different file format (if needed), after which the wizard disappears. If user chooses to process the DOCUMENT the user can change the image (preview) and soft-rescan it, select regions (straighten the image), change resolutions and save. The user gets the 7 option to run post processing (registered plug-ins) like OCR and follow-up tasks like ‘post to vendor print website’, etc.

The arrived DOCUMENT is routed to a default ROUTING-DESTINATION, which can be the current console user's Document Library or a public location on the PC where any users of this PC can access the DOCUMENT.

Enterprise Capture (SCAN-SERVICE)

In this use case, the main actor is the SCAN-SERVICE and the environment is: SORG, MORG or Enterprise with a Managed Network. SCAN-SERVICE interacts with the ENTERPRISE-SCAN-DEVICE to receive the SCANNED-DOCUMENT from the DEVICE. SCAN-SERVICE then creates a DOCUMENT from the SCANNED-DOCUMENT and passes the resulting DOCUMENT to the ROUTING-SERVICE for delivery.

If the scan was successful (i.e. SCAN-SERVICE receives the SCANNED-DOCUMENT from the ENTERPRISE-SCAN-DEVICE), the SCAN-SERVICE creates a DOCUMENT based on the SCANNED-DOCUMENT and populates the DP-JOB-TICKET in the DOCUMENT based on job information in the SCANNED-DOCUMENT. In a case where the ENTERPRISE-SCAN-DEVICE was not able to send a complete ROUTING-TICKET up, the SCAN-SERVICE might need to populate that information based on default ROUTING-TICKETs or searching for the SCAN-INITIATOR's DP-JOB-TICKETs in the DP-DIRECTORY.

It is possible that the SCAN-SERVICE may receive a partial or no SCANNED-DOCUMENT from the ENTERPRISE-SCAN-DEVICE due to some scan error. In this case, the SCAN-SERVICE creates a DOCUMENT based on the partial SCANNED-DOCUMENT and populates the DP-JOB-TICKET and includes the error information in the DOCUMENT.

The SCAN-SERVICE then sends the DOCUMENT to ROUTING-SERVICE so it gets routed to the proper ROUTING-DESTINATION.

Deliver Document

This section covers use cases for setting up document delivery options and delivering in the enterprise and in the home, each of which is discussed under its own sub-heading.

Enterprise Deliver

In this use case, the main actor is the ROUTING-SERVICE and the environment is: SORG, MORG or Enterprise.

In this case, the ROUTING-SERVICE receives a DOCUMENT containing the DP-JOB-TICKET. The ROUTING-SERVICE retrieves the routing information from the ROUTING-TICKET contained in the DP-JOB-TICKET. If there is a need, the ROUTING-SERVICE will try to complete the missing routing information (resolving a name, etc) and complete the routing information in the DP-JOB-TICKET that is contained within the DOCUMENT. If that fails, the ROUTING-SERVICE communicates back to the ROUTING-ORIGIN that the routing information is not complete and can not be calculated. The ROUTING-SERVICE then fails the ROUTING-TASK and generates an ERROR-NOTIFICATION.

Based on and assuming the presence of the routing information, the ROUTING-SERVICE routes the DOCUMENT to a ROUTING-DESTINATION. This step might, in some embodiments, require authentication to the ROUTING-DESTINATION on behalf of the ROUTING-ORIGIN.

If there is an error in either of the steps above or upon successful routing, the ROUTING-SERVICE sends an appropriate NOTIFICATION. Notification use cases are described below in their own section.

Home Deliver

In this use case, the main actor is the ROUTING-SERVICE and the environment is the HOME. In this example, the ROUTING-SERVICE receives a DOCUMENT containing the DP-JOB-TICKET. The ROUTING-SERVICE retrieves the routing information from the ROUTING-TICKET contained in the DP-JOB-TICKET. If there is a need, ROUTING-SERVICE will try to complete the missing routing information and complete the routing information in the DP-JOB-TICKET contained in the DOCUMENT. Alternately, it communicates back to the ROUTING-ORIGIN that the routing information is not complete and can not be calculated. The ROUTING-SERVICE then fails the ROUTING-TASK and generates ERROR-NOTIFICATION.

Assuming the presence of and based on routing information, the ROUTING-SERVICE routes the DOCUMENT to a ROUTING-DESTINATION. The ROUTING-DESTINATION can be a SOFTWARE-APPLICATION, a DOCUMENT-RECIPIENT or a folder.

If there is an error in either steps or upon successful routing, ROUTING-SERVICE sends an appropriate NOTIFICATION. Notification use cases are described below in their own section.

Notify

This section covers use cases for setting up notifications on the status of document routing. In this section, there are the following sub-sections: Enterprise Notify, Enterprise Receive Notification, Information Worker Receive Notification, Document Service Receive Notification, and Home Receive Notification.

Enterprise Notify

In this use case, the main actor is the ROUTING-SERVICE and the environment is: SORG, MORG or Enterprise. If there is an error in any step of routing or upon successful routing, the ROUTING-SERVICE sends a relevant NOTIFICATION to the ROUTING-DESTINATION. The ROUTING-DESTINATION is retrieved from the ROUTING-TICKET contained within the DP-JOB-TICKET.

Enterprise Receive Notification

In this use case, the main actor is the RECEIVING-AGENT and the environment is: SORG, MORG or Enterprise.

Here, RECEIVING-AGENT on a PC is receiving a NOTIFICATION on behalf of a DOCUMENT-RECIPIENT or a SOFTWARE-APPLICATION on that PC.

The RECEIVING-AGENT receives all NOTIFICATIONs and passes them on to the DOCUMENT-RECIPIENT it was intended for, or the RECEIVING-AGENT stores the NOTIFICATIONs in a default folder that is determined by the DOCUMENT-RECIPIENT. If the NOTIFICATION was intended to go to the SOFTWARE-APPLICATION it is routed accordingly.

Information Worker Receive Notification

In this use case, the main actor is the INFORMATION-WORKER and the environment is: SORG, MORG or Enterprise. An INFORMATION-WORKER receives a NOTIFICATION balloon when logged on and can browse all NOTIFICATIONs received. The INFORMATION-WORKER can also receive the NOTIFICATION in his email.

Document Service Receive Notification

In this use case, the main actor is the DOCUMENT-RECEIVING-SERVICE and the environment is: SORG, MORG or Enterprise.

If the DOCUMENT-RECEIVING-SERVICE has registered for a NOTIFICATION of a delivery (via the DP-API), it will receive the NOTIFICATION. The API parameter will be the destination for the NOTIFICATION. For example, an application can request a DOCUMENT to be delivered to Sharepoint® brand products and ask for a delivery receipt.

Home Receive Notification

In this use case, the main actor is the HOME-PC-USER and the environment is the HOME. In this example, the HOME-PC-USER can receive a DOCUMENT-ARRIVAL-NOTIFICATION in his session (balloon) or in a default folder on his PC. The HOME-PC-USER can browse all the NOTIFICATIONs received.

Receive Document

This section covers use cases for receiving a document in an enterprise or at home, and has the following sub-sections: Enterprise Receive Document, Enterprise Receive by Document Receiving Services, and Home Receive Document.

Enterprise Receive Document

In this use case, the main actor is the RECEIVING-AGENT agent and the environment is: SORG, MORG or Enterprise. The RECEIVING-AGENT on a PC receives a DOCUMENT on behalf of a DOCUMENT-RECIPIENT or a SOFTWARE-APPLICATION on that PC.

Upon arrival of a new DOCUMENT, the RECEIVING-AGENT retrieves the ROUTING-DESTINATION from the DP-JOB-TICKET contained within the DOCUMENT. The DOCUMENT-RECIPIENT or the SOFTWARE-APPLICATION are two example destinations.

The DOCUMENT is then to be delivered to a DOCUMENT-RECIPIENT. The RECEIVING-AGENT finds out if the person is logged on to his/her PC. If the DOCUMENT-RECIPIENT is logged on, the RECEIVING-AGENT retrieves the DOCUMENT-RECIPIENT's preferences for receiving documents. If the person has setup a folder for automatic delivery of DOCUMENTs, the RECEIVING-AGENT delivers the document there. If there is a SOFTWARE-APPLICATION to receive the document, the RECEIVING-AGENT launches the SOFTWARE-APPLICATION if not launched already. If there are multiple SOFTWARE-APPLICATIONs associated with document arrival, the DOCUMENT-RECIPIENT gets a balloon notification informing him of the delivery and the applications available to open the document with. If none of the above cases occurs, the default is to launch the Document Acquisition Wizard.

If the DOCUMENT-RECIPIENT is not in session, the RECEIVING-AGENT holds on to the arrived DOCUMENT in its ‘arrived document queue’ until the DOCUMENT-RECIPIENT logs on.

If the DOCUMENT is to be delivered to a SOFTWARE-APPLICATION, the RECEIVING-AGENT launches the SOFTWARE-APPLICATION with the DOCUMENT. If the SOFTWARE-APPLICATION is running already, it is notified of the DOCUMENT arrival.

If the DOCUMENT is to be delivered to a folder ROUTING-DESTINATION and there is the proper credential to do so, the DOCUMENT is delivered to that ROUTING-DESTINATION on the PC.

Enterprise Receive by Document Receiving Services

In this use case, the main actor is DOCUMENT-RECEIVING-SERVICE and the environment is: SORG, MORG or Enterprise. Here, DOCUMENT-RECEIVING-SERVICE receives DOCUMENTs from the ROUTING-SERVICE it is registered with as a valid document recipient.

The DOCUMENT-RECEIVING-SERVICE receives the NOTIFICATION and DOCUMENTs sent by ROUTING-SERVICE via the DOCUMENT-RECEIVING-SERVICE's preferred method. The method is passed to the ROUTING-SERVICE via the DP-API when the DOCUMENT-RECEIVING-SERVICE (e.g. Sharepoint® products) registered with DP.

Home Receive Document

In this use case, the main actor is the RECEIVING-AGENT at Home and the environment is: HOME. Here, RECEIVING-AGENT on a PC receives a DOCUMENT on behalf of a DOCUMENT-RECIPIENT or a SOFTWARE-APPLICATION on that PC.

In this case, operation is identical to the Enterprise Receive a Document use case.

Manage

This section covers use cases for managing DP and its components via the DP management console and has the following sub-sections: Enterprise Manage Job, Enterprise Manage Job Ticket, Enterprise Setup Deliver, Enterprise Manage Device, Enterprise Manage DP, and Home Manage DP and DP Tickets.

Enterprise Manage Job

In this use case, the main actor is the DP-JOB-MANAGER and the environment is: SORG, MORG or Enterprise. A DP-JOB-MANAGER can be an INFORMATION-WORKER and/or a DP-ADMINISTRATOR.

In this example, the DP-JOB-MANAGER can browse his DP-JOBs or the DP-JOBS to which he has read access. The DP-JOB-MANAGER can view job information such as JOB-INITIATOR, status, pages, size, time and date, etc. The DP-JOB-MANAGER can cancel his DP-JOBs (or any job he has write access to). The DP-JOB and any of its remaining sub-tasks is then cancelled. If the DP-JOB included a SCAN-TASK that is to be cancelled, the SCANNED-DOCUMENT is purged from the SCAN-DEVICE and the SCAN-SERVICE. Note that after a scan is complete (SCANNED-DOCUMENT has been fully transferred to the SCAN-SERVICE) and the successful transmission has been acknowledged by the SCAN-SERVICE, the SCAN-TASK is completed and can not be canceled.

The DP-JOB-MANAGER can also cancel a TASK. When, for example, a ROUTING-TASK is canceled, the ROUTING-SERVICE is instructed to stop the routing and execute the necessary cleanup steps. If a DOCUMENT has already been routed, the cancellation does not take effect unless the DOCUMENT was intended for multiple recipients. In that case, the cancellation process stops further routing to the remaining destinations where the DOCUMENT was to be routed to. The ROUTING-SERVICE will still send the necessary NOTIFICATION for partial delivery.

For example, assume a ROUTING-TASK was to send Jim's DOCUMENT to both Nancy and Bill. Jim expects to receive a SUCCESS-NOTIFICATION. If the ROUTING-TASK is cancelled right after the ROUTING-SERVICE sent the DOCUMENT to Bill, but before it is sent to Nancy, the ROUTING-SERVICE no longer delivers the DOCUMENT to Nancy. The ROUTING-SERVICE however still sends a NOTIFICATION to Jim informing him that the DOCUMENT was successfully received by Bill. Partial delivery, notification and cancellation of the ROUTING-TASK are logged by the ROUTING-SERVICE. Similarly, a SCAN-TASK or a DOCUMENT-PROCESSING-TASK can be cancelled.

The DP-JOB-MANAGER can also pause a DP-JOB, resume a paused DP-JOB, and schedule a DP-JOB to execute at a later time.

Enterprise Manage Job Ticket

In this use case, the main actor is the DP-JOB-TICKET-MANAGER and the environment is: SORG, MORG or Enterprise. A DP-JOB-TICKET-MANAGER can be an INFORMATION-WORKER, DP-ADMINISTRATOR or a SOFTWARE-APPLICATION. While the INFORMATION-WORKER and the DP-ADMINISTRATOR use the MANAGEMENT-CONSOLE to manage their DP-JOBs, the SOFTWARE-APPLICATION uses the DP-API to do so. Each actor can access DP-JOB-TICKETs based on his/her access rights.

For example a DP-ADMINISTRATOR has all read/write permissions on s all DP-JOB-TICKETs, whereas the INFORMATION-WORKER only has write access to some DP-JOB-TICKETs but not all. SOFTWARE-APPLICATIONs can access the DP-JOB-TICKETs they have access to. Managing a DP-JOB-TICKET means creating, modifying, copying, deleting, pushing down to the ENTERPRISE-SCAN-DEVICE and purging the DP-JOB-TICKET from the ENTERPRISE-SCAN-DEVICE.

The DP-JOB-TICKET-MANAGER can create a new DP-JOB-TICKET. In this example, creating a DP-JOB-TICKET involves the DP-JOB-TICKET, the ROUTING-TICKET, the SCAN-TICKET and the DOCUMENT-PROCESSING-TICKET.

With regard to the DP-JOB-TICKET, consider the following. The DP-JOB-TICKET-MANAGER defines the DP-JOB-TICKET owner and sets up permissions on the DP-JOB-TICKET. The owner can be a single user, a group, the admin, a SOFTWARE-APPLICATION, etc.

With regard to the ROUTING-TICKET, the DP-JOB-TICKET-MANAGER defines the ROUTING-DESTINATIONs for the DOCUMENT. This defines the ROUTING-TICKET portion of a DP-JOB-TICKET. The DP-JOB-TICKET-MANAGER also sets up NOTIFICATIONs.

With regard to the SCAN-TICKET, the DP-JOB-TICKET-MANAGER defines the desired scan attributes in the SCAN-TICKET. This defines the SCAN-TICKET portion of the DP-JOB-TICKET. The DP-JOB-TICKET-MANAGER defines what to do in case an error occurs during the scanning process.

With regard to the DOCUMENT-PROCESSING-TICKET, if a DOCUMENT-PROCESSING-TASK is desired then such a ticket needs to be i defined by the DP-JOB-TICKET-MANAGER.

The DP-JOB-TICKET-MANAGER can browse his private DP-JOB-TICKETs and public (group or global) DP-JOB-TICKETs stored at the DP-JOB-TICKET-SERVICE. An example of a group ticket is a DP-JOB-TICKET intended by use for only people in the legal team. An example of a global ticket is a DP-JOB-TICKET defined for any employee to scan an expense report to be sent to the Expense Department. The DP-JOB-TICKET-MANAGER can only browse those public Tickets that he has read access to.

The DP-JOB-TICKET-MANAGER can select his private DP-JOB-TICKET (or a group of DP-JOB-TICKETs) to be managed. The DP-JOB-TICKET-MANAGER can modify a DP-JOB-TICKET, save it as a new DP-JOB-TICKET or delete a DP-JOB-TICKET.

The DP-JOB-TICKET-MANAGER can also select a public DP-JOB-TICKET (or a group of DP-JOB-TICKETs) to be managed. A DP-JOB-TICKET-MANAGER can manage a public DP-JOB-TICKET if he/she has been given the write access to do so. The DP-JOB-TICKET-MANAGER can modify a public DP-JOB-TICKET, save it as a new DP-JOB-TICKET or delete a DP-JOB-TICKET.

DP-JOB-TICKET-MANAGER can select one or multiple DP-JOB-TICKETs to push down to one or multiple ENTERPRISE-SCAN-DEVICES.

Enterprise Setup Deliver

In the use case, the main actor is the DP-JOB-TICKET-MANAGER and the environment is: SORG, MORG or Enterprise.

With regard to setting up a ROUTING-TICKET, consider the following. A ROUTING-TICKET is filled out with information on the ROUTING-DESTINATION(s), error information and credentials needed for routing the DOCUMENT by the ROUTING-SERVICE.

The ROUTING-DESTINATION can be, by way of example and not limitation, one of multiple destinations of the following types:
DOCUMENT-RECEIVING-SERVICE, such as Sharepoint® brand products, WINFS;
SOFTWARE-APPLICATION;
INFORMATION-WORKER's email address; and/or
DOCUMENT-RECIPIENT.

Credentials can be obtained or provided in the following ways. Credentials can, be provided by the SCAN-OPERATOR at pre-scan, by the sender in the ROUTING-TICKET, and/or obtained from a credential repository.

In the case of an error, the following actions can be taken. A default destination for routing the DOCUMENT can be provided, such as the sender's email address or a public share. Alternately, the DP-ADMINISTRATOR can specify that nothing is to be done. Alternately, destinations can be provided to which the ERROR-NOTIFICATION can be sent. Alternately, a default, set by the DP-ADMINISTRATOR, can be used.

Enterprise Manage Device

In this use case, the main actor is the DP-ADMINISTRATOR and the environment is: SORG, MORG or Enterprise.

In this example, the ENTERPRISE-SCAN-DEVICE can be installed and uninstalled, as provided in the Install Use Cases above.

With regard to managing SCAN-DEVICE-POLICY, consider the following. An example of a SCAN-DEVICE-POLICY is assigning an ENTERPRISE-SCAN-DEVICE to one group of users, like the legal team only. SCAN-DEVICE-POLICY can be very simple as in the case of home users or small businesses, or it can be more complicated and rigid, as in the case of an enterprise.

Management can also pertain to publishing or unpublishing the ENTERPRISE-SCAN-DEVICE. The devices can be published, for example, in a corporate directory to facilitate global browsing. The ENTERPRISE-SCAN-DEVICE identity, SCAN-DEVICE-CAPABILITES and SCAN-DEVICE-POLICY can all be made available in the corporate directory for browsing.

Management activities can also pertain to pushing DP-JOB-TICKETs to an ENTERPRISE-SCAN-DEVICE for use. For example, the DP-ADMINISTRATOR can push a selective set of DP-JOB-TICKETs in its directory to an ENTERPRISE-SCAN-DEVICE given constraints like memory on the ENTERPRISE-SCAN-DEVICE or SCAN-DEVICE-POLICY.

Management activities can also pertain to purging DP-JOB-TICKETs from an ENTERPRISE-SCAN-DEVICE and to populating DP-USERs to the 1I ENTERPRISE-SCAN-DEVICE. These are the users that can authenticate to the SCAN-DEVICE and use it.

Enterprise Manage DP

In this use case, the main actor is the DP-ADMINISTRATOR and the environment is: SORG, MORG or Enterprise.

The DP-ADMINISTRATOR can deploy and configure DP services such as SCAN-SERVICE, ROUTING-SERVICE, DOCUMENT-PROCESSING-SERVICE. Doing this, the DP-ADMINISTRATOR can manage services logs, their size and location. The DP-ADMINISTRATOR can set up a default folder for the SCAN-SERVICE to monitor for incoming SCANNED-DOCUMENTs for cases where an ENTERPRISE-SCAN-DEVICE is not installed on a system, but there still exists a need to process finished files arriving from that ENTERPRISE-SCAN-DEVICE. The default folder can become available to the ENTERPRISE-SCAN-DEVICE to copy the SCANNED-DOCUMENT to, and the SCAN-SERVICE to pick up from. This can provide support for some legacy ENTERPRISE-SCAN-DEVICEs that might not be able to directly communicate with the SCAN-SERVICE. In this example, the DP-ADMINISTRATOR has access to all basic and advanced properties of the MANAGEMENT-CONSOLE and manages DP-USERS and SCAN-DEVICES in the DP-DIRECTORY.

Home Manage DP and DP Tickets

In this use case, the main actor is the HOME-PC-USER and the environment is: HOME. The assumption in this case is that each PC at home has DP deployed and SCAN-DEVICE installed.

Here, the HOME-PC-USER accesses the HOME-MANAGEMENT-CONSOLE for setting up logs and basic properties of DP and sets up defaults for the ROUTING-DESTINATION for all incoming DOCUMENTS. The HOME-PC-USER can also set up a SCAN-TICKET using the HOME-MANAGEMENT-CONSOLE.

The HOME-PC-USER can set up a ROUTING-TICKET using the HOME-MANAGEMENT-CONSOLE. To do so, he or she fills out the ROUTING-TICKET with ROUTING-DESTINATION information. The ROUTING-DESTINATION can be one or more of the following types:
SOFTWARE-APPLICATION; This is an application running on the HOME-PC-USER's PC;
DOCUMENT-RECIPIENT; This is a HOME-PC-USER. The DOCUMENT will be routed to that HOME-PC-USER's console session. If the DOCUMENT-RECIPIENT is logged on, he will get a balloon notification of DOCUMENT arrival. Otherwise, delivery fails;
a physical location on the HOME-PC-USER's PC like a folder where the incoming DOCUMENT can be deposited.

Audit

This section covers use cases for DP logging and behavior monitoring for auditing and accounting purposes.

DP Logging

In this use case, the main actor is the DP-SERVICE and the environment: is SORG, MORG or Enterprise. Each DP-SERVICE logs its activity and associated information in its log file. The DP-ADMINISTRATOR manages the log files using the MANAGEMENT-CONSOLE.

DP Monitoring

In this use case, the main actor is the DP-ADMINISTRATOR and the environment is: SORG, MORG or Enterprise. The DP-ADMINISTRATOR uses the MANAGEMENT-CONSOLE to setup and view logs and do accounting. For example, the DP-ADMINISTRATOR can find out how many DP-JOBs were processed or how many specific TASKs (SCAN-TASK, ROUTING-TASK, etc) were processed in a given period of time. The DP-ADMINISTRATOR can monitor activity and health of each DP-SERVICE within the DP via the MANAGEMENT-CONSOLE.

Browse

This section covers use cases for browsing the DP capabilities and SCAN-DEVICES from the user's (INFORMATION-WORKER or HOME-PC-USER) desktop and has the following sub-sections: Enterprise Browsing and Home Browsing.

Enterprise Browsing

In this use case, the main actor is the INFORMATION-WORKER and the environment is: SORG, MORG and enterprise.

The INFORMATION-WORKER can browse published ENTERPRISE-SCAN-DEVICEs within his/her corporation and see all published ENTERPRISE-SCAN-DEVICEs (i.e. the ones added to the corporate directory). When the INFORMATION-WORKER browses an ENTERPRISE-SCAN-DEVICE, he can view the properties of each ENTERPRISE-SCAN-DEVICE including SCAN-DEVICE-CAPABILITIES and SCAN-DEVICE-POLICY. If the INFORMATION-WORKER is a valid user of the ENTERPRISE-SCAN-DEVICE (i.e. he has access to the ENTERPRISE-SCAN-DEVICE), he can see the DP-JOB-TICKETs on the SCAN-DEVICE. He can browse the job queue for that ENTERPRISE-SCAN-DEVICE. He can also browse any ENTERPRISE-SCAN-DEVICE storage if he has the required read access rights.

If the INFORMATION-WORKER does not have access to the ENTERPRISE-SCAN-DEVICE, he can request access (for example, right-clicking on a device and requesting access). The access request can be sent to the DP-ADMINISTRATOR for approval. The DP-ADMINISTRATOR can view the request in the MANAGEMENT-CONSOLE and can access or deny a request. The INFORMATION-WORKER can then receive an email with confirmation or denial of the access request.

An INFORMATION-WORKER can browse a DP as follows. The INFORMATION-WORKER can browse all the ENTERPRISE-SCAN-DEVICEs that are available on that DP, including the ones that have been shared to the INFORMATION-WORKER. He can further browse an ENTERPRISE-SCAN-DEVICE as described above. The INFORMATION-WORKER can browse his personal and public DP-JOB-TICKETS as discussed above. The INFORMATION-WORKER can browse all DOCUMENT-PROCESSING-PLUG-INs available in the DP.

The INFORMATION-WORKER can also browse his arrived DOCUMENTs available in his Document Library and the NOTIFICATIONs in any suitable email client.

Home Browsing

In this use case, the main actor is the HOME-PC-USER and the environment is the HOME. Here, the HOME-PC-USER can browse an installed HOME-SCAN-DEVICE and can view the properties of each HOME-SCAN-DEVICE. He can browse the DP-JOB-TICKETs on the HOME-SCAN-DEVICE, as well as the job queue for that SCAN-DEVICE. He can also browse storage on the HOME-SCAN-DEVICE.

The HOME-PC-USER can browse his received DOCUMENTs in his Document Library, as well as the NOTIFICATIONs in, for example, Outlook Express.

### CONCLUSION

In the embodiments illustrated and described above, scanning solutions are presented which, from a user's standpoint (either a sender or receiver), are simplistic and intuitive to use. In at least some embodiments, scanned documents can be sent to various digital destinations in which the documents can then be consumed by an end user or system in an intuitive and user-friendly manner.

In addition, various embodiments provide infrastructure support for imparting, to the scanning functionality, features that greatly enhance the user's ability to consume and use scanned documents.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
scanning a document to produce a scanned document; and
sending the scanned document to a digital destination other than a device that initiated said scanning, wherein said sending comprises sending the scanned document as a message and not as an attachment to a message.

2. The method of claim 1, wherein the digital destination comprises an application.

3. The method of claim 1, wherein the digital destination comprises a folder.

4. The method of claim 1, wherein the digital destination comprises an inbox.

5. The method of claim 1, wherein the digital destination comprises a routing component that is configured to route the scanned document to other digital destinations.

6. The method of claim 1 further comprising authenticating one or more users prior to allowing the one or more users to scan a document.

7. The method of claim 1 further comprising authenticating one or more users prior to allowing the one or more users to scan a document and, after said authenticating, performing said acts of scanning and sending responsive to a single user action.

8. The method of claim 1 further comprising providing one or more profiles for selection by a user, wherein the one or more profiles individually indicate one or more digital destinations and processing information associated with the document.

9. A method comprising:
providing, in addition to scanning functionality, at least one other functionality selected from a group comprising: copying, printing or faxing;
scanning a document to produce a scanned document;
sending the scanned document to a digital destination other than a device that initiated said scanning, wherein said sending comprises sending the scanned document as a message and not as an attachment to a message.

10. The method of claim 9, wherein the digital destination comprises one or more of an application, a folder, an inbox, or a routing component that is configured to route the scanned document to other digital destinations.

11. The method of claim 9 further comprising authenticating one or more users prior allowing the one or more users to scan a document.

12. The method of claim 9 further comprising authenticating one or more users prior allowing the one or more users to scan a document and after said authenticating, performing said acts of scanning and sending responsive to a single user action.

13. The method of claim 9 further comprising providing one or more profiles for selection by a user, wherein the one or more profiles individually indicate one or more digital destinations.

14. The method of claim 9, wherein the digital destination comprises an inbox that is configured as an inbox for at least one other of the functionalities.

15. A method comprising:
scanning a document to produce a scanned document; and
sending the scanned document to one or more inboxes, wherein said sending comprises sending the scanned document as a message and not as an attachment to a message.

16. The method of claim 15, wherein said inbox is configured to receive fax documents.

17. The method of claim 15, wherein said inbox is configured to receive email messages.

18. The method of claim 15, wherein said inbox is configured to receive fax and email messages.

19. The method of claim 15 further comprising authenticating one or more users prior allowing the one or more users to scan a document.

20. The method of claim 15 further comprising providing one or more profiles for selection by a user, wherein the one or more profiles individually indicate one or more digital destinations.
